(19) United States
(12) Patent Application Publication
(10) Pub. No.: US 2005/0198404 A1
(43) Pub. Date: Sep. 8, 2005

(54) Semiconductor device and electronic apparatus

(76) Inventors: Takahiro Kawakami, Ikoma-shi (JP); Naoyuki Kamei, Yamatokoriyama-shi (JP); Sohichi Yoshimura, Nara-shi (JP); Kazushi Yamaneki, Yamatokoriyama-shi (JP)

Correspondence Address: EDWARDS & ANGELL, LLP, P.O. BOX 55874, BOSTON, MA, 02205, US

(21) Appl. No.: 11/073,422

(22) Filed: Mar. 4, 2005

(30) Foreign Application Priority Data
Mar. 5, 2004 (JP) 2004-062981

(51) Int. Cl. G06F 3/00

(52) U.S. Cl. 710/1

(57) ABSTRACT

An ASIC (semiconductor device) of an image processing section is provided with an input/output circuit for performing input and output to and from an image processing circuit and a confidential circuit. The input/output circuit performs output to outside of the ASIC at a timing shifted from a timing of output from the confidential circuit, for example, so as to hide the processing of the confidential circuit. With this arrangement, it is possible to hide an algorithm in the confidential circuit. Further, the ASIC is provided with a decryption circuit for decrypting an encrypted program stored in a nonvolatile memory provided separately from the ASIC. The decryption circuit is caused to function as a decryption section upon later-writing into an OTP.

This Nonprovisional application claims priority under 35 U.S.C. § 119(a) on Patent Application No. 2004/62981 filed in Japan on Mar. 5, 2004, the entire contents of which are hereby incorporated by reference.

### FIELD OF THE INVENTION

The present invention relates to a semiconductor device including a programmable circuit and an electronic apparatus including the semiconductor device.

### BACKGROUND OF THE INVENTION

In recent years, attention has been given to programmable circuits that the user can program as desired at his/her site.

For example, an arrangement has been suggested in which part of gate arrays is changed to a FPGA (Field Programmable Gate Array) so that the user can change the processing, holding high speed performance and high packaging density of a masked GA (Gate Array) (see Patent Document 1: Japanese Laid-Open Patent Application No. 1994/275718 (Tokukaihei 6-275718; published on Sep. 30, 1994)).

As one example of the use of such a programmable circuit, an arrangement has been suggested in which a PLD (Programmable Logic Device) has decryption means and key holding means, and operation is performed only by a program encrypted with a previously set key so that unauthorized copy of the program is prevented (see Patent Document 2: Japanese Laid-Open Patent Application No. 1994/187246 (Tokukaihei 6-187246; published on Jul. 8, 1994)).

Further, an arrangement for protecting copy of a FPGA program from a FPGA element has been suggested (see Patent Document 3: Japanese Laid-Open Patent Application No. 2003/84853 (Tokukai 2003-84853; published on Mar. 19, 2003)).

However, the conventional semiconductor devices have the problem that an internal algorithm written into the programmable circuit might not be reliably hidden.

For example, in the arrangement in Patent Document 1, algorithm and logic might be analyzed by reading ROM storing the program. Further, in the arrangement in Patent Document 2, although a program in ROM is encrypted, algorithm and logic might be figured out by analyzing operation of the PLD itself.

### SUMMARY OF THE INVENTION

The present invention has been attained to solve the above problem, and an object of the present invention is to provide a semiconductor device and an electronic apparatus both of which can hide processing of a circuit in a black-box manner so as to make analysis of an internal algorithm difficult.

A semiconductor device according to the present invention, in order to solve the above problem, includes a programmable circuit and a fixed logic circuit and composed of an input/output section for performing input and output of data to and from the programmable circuit and the fixed logic circuit, wherein: the input/output section hides, from an entity outside the semiconductor device, input and output of data to and from the programmable circuit.

The programmable circuit is a circuit that can be programmed by writing. As the programmable circuit, for example, a volatile programmable circuit is used. The programmable circuit may be nonvolatile. The fixed logic circuit is an unrewritable circuit. The fixed logic circuit is nonvolatile.

In the above arrangement, the input/output section hides, from an entity outside the semiconductor device, input and output of data to and from the programmable circuit.

For example, the input/output section performs output at a timing delayed from an output timing from the programmable circuit. In addition, for example, the input/output section performs acquisition of program data to be supplied to the programmable circuit, at a timing delayed from a normally expected timing.

This arrangement hides input and output of data to and from the programmable circuit. This makes it difficult to figure out processing in the programmable circuit even if analysis is performed by an entity outside the semiconductor device. Therefore, it is possible to make unauthorized analysis of an algorithm processed in the programmable circuit difficult.

Further, it is possible to prevent the use of a false signal acting like an output from the programmable circuit by hiding an output from the programmable circuit of the semiconductor device. This can prevent unauthorized use of the semiconductor circuit.

Still further, the programmable circuit may be realized by FPGA (Field Programmable Gate Array). This arrangement can be realized easily.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram schematically illustrating an image forming apparatus including one example of a semiconductor device according to the present invention.

FIG. 2 is a block diagram illustrating steps for manufacturing the semiconductor device.

FIG. 3 is a flowchart illustrating steps for manufacturing the semiconductor device.

FIG. 4(a) is a block diagram illustrating part of one example of the semiconductor device, and FIG. 4(b) is a flowchart illustrating how the semiconductor device operates.

FIG. 5(a) is a block diagram illustrating part of another example of the semiconductor device, and FIG. 5(b) is a flowchart illustrating how the semiconductor device operates.

FIG. 6(a) is a block diagram illustrating part of still another example of the semiconductor device, and FIG. 6(b) is a flowchart illustrating how the semiconductor device operates.

FIG. 7 is a block diagram schematically illustrating an image forming apparatus including another example of a semiconductor device according to the present invention.

FIG. 8 is a flowchart illustrating how the semiconductor device operates.

FIG. 9 is a flowchart illustrating how the semiconductor device operates.

FIG. 10 is a block diagram schematically illustrating an image forming apparatus including still another example of a semiconductor device according to the present invention.

FIG. 11 is a block diagram schematically illustrating part of a conventional semiconductor device.

### DESCRIPTION OF THE EMBODIMENTS

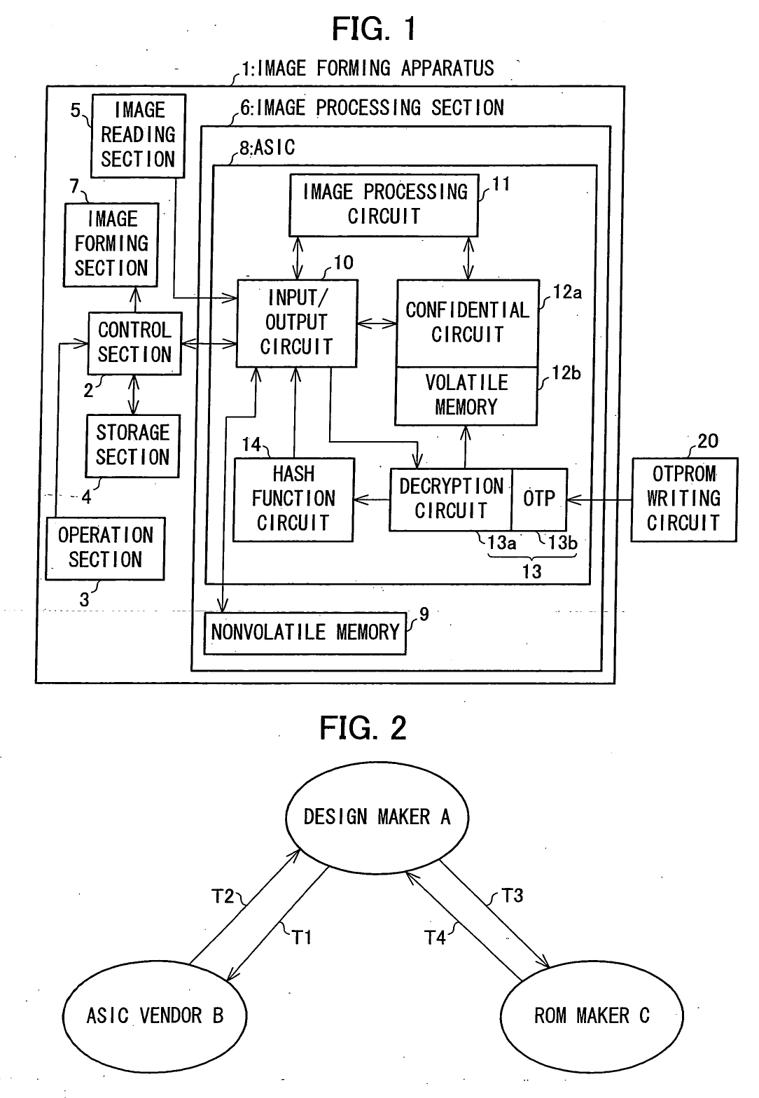

The following will describe one embodiment of the present invention with reference to FIGS. 1 through 10.

A semiconductor device of the present embodiment, as illustrated in FIG. 1, is included as an ASIC (Application Specific Integrated Circuit) 8 in an image forming apparatus (electronic apparatus) 1.

The image forming apparatus 1 forms an image on a sheet. The image forming apparatus 1 can communicate information with an entity outside the image forming apparatus 1 via an input/output interface (not shown).

The image forming apparatus 1 includes a control section 2, an operation section 3, a storage section 4, an image reading section 5, an image processing section (semiconductor device) 6, and an image forming section 7.

The control section 2 controls operation of the image forming apparatus 1. The control section 2 of the present embodiment is realized by hardware. However, the present invention is not limited to this. The control section 2 may be realized by a CPU (Central Processing Unit) of the image forming apparatus 1 loading and executing a program stored in the storage section 4.

The operation section 3 detects an operation instruction given from a user for output to the control section 2. The operation section 3 includes a display section (not shown) for displaying an operation status.

The storage section 4 is a memory for storing data. The storage section 4 may store a program for causing the CPU to function as the control section 2.

The image reading section 5 is one for reading an image formed on the sheet. When the control section 2 outputs a start signal in response to a user's instruction detected by the operation section 3, the image reading section 5 starts image reading of a document placed on a stage (not shown). The image reading section 5 outputs image data read from the document, to the image processing section 6.

The image processing section 6 performs a predetermined image processing with respect to incoming image data. The image processing section 6, upon receipt of image data from the image reading section 5, performs image processing and then outputs the image data to the image forming section 7. The image processing section 6 of the present embodiment is a semiconductor device having the ASIC 8 and the nonvolatile memory (storage device) 9 integrally packaged therein. The image processing section 6 will be described later.

The image forming section 7 forms an image on a sheet in accordance with image data. The image forming section 7, upon receipt of the image data from the image processing section 6 through the control section 2, forms an image on the sheet in accordance with this image data.

The above-arranged image forming apparatus 1, in order to prevent a predetermined document (hereinafter referred to as specific document), such as a bill, from being copied, has a specific document extracting function for recognizing a specific document and protecting the specific document from being printed. The following will describe the specific document extracting function.

In the image forming apparatus 1, using image data of a document read by the image reading section 5, the image processing section 6 determines whether the document is the specific document. The image processing section 6 performs determination of the image data fed in the above-described manner so as to output a detection signal indicating whether the document is the specific document to the control section 2. The image processing section 6 will be described in detail as follows.

The image processing section 6 includes the ASIC (semiconductor device) 8 and the nonvolatile memory 9.

The ASIC 8 is a semiconductor device for realizing an image processing function of the image forming apparatus 1. In order to keep details of the specific document extracting function a secret, an entire circuit of the ASIC 8 is realized by at least a partially rewritable and programmable circuit loading a program (program data) rather than a fixed logic circuit with a fixed layout. This prevents logic from being figured out from the layout.

The nonvolatile memory 9 is a storage area of an encrypted program for operating a confidential circuit (programmable circuit) 12a of the ASIC 8. The nonvolatile memory 9 of the present embodiment is realized by ROM. The nonvolatile memory 9 is first provided independently from the ASIC 8. Thereafter, the nonvolatile memory 9 is packaged with the ASIC 8 into one semiconductor device. This packaged semiconductor device is the image processing section 6.

The ASIC 8 is provided with an input/output circuit (input/output section) 10, an image processing circuit 11, a confidential circuit 12a, a volatile memory 12b, a decryption section 13, and a hash function circuit (unidirectional hash function section) 14.

The input/output circuit 10 is an input/output interface of the ASIC 8. The input/output circuit 10 receives data supplied from the control section 2 to the ASIC 8, and then outputs the data to its destination circuit such as the image processing circuit 11, the confidential circuit 12a, or a decryption circuit 13a. In addition, the input/output circuit 10 temporarily receives data supplied from each circuit in the ASIC 8, and then outputs it to the control section 2. The input/output circuit 10 functions as an input/output section for hiding input and output to and from the confidential circuit 12a. This will be described later.

The image processing circuit 11 performs a predetermined image processing with respect to incoming image data. Taking, as an example, the case where the operation section 3 in the image forming apparatus 1 has detected a scaling instruction given from the user, the image processing circuit 11 performs scaling processing with respect to image data supplied from the image reading section 5 through the input/output circuit 10, and then outputs a resultant data to the control section 2 through the input/output circuit 10.

The confidential circuit 12a and the volatile memory 12b are volatile and programmable circuits. This confidential circuit 12a performs confidential processing that is kept secret to external entities.

The confidential circuit 12a of the present embodiment performs determination whether the document is the specific document. The confidential circuit 12a determines whether incoming image data is derived from the specific document, and outputs a detection signal indicating a determination result through the input/output circuit 10 to the outside of the image processing section 6. The confidential circuit 12a makes the determination based on image data read by the image reading section 5 and supplied thereto through the input/output circuit 10 and image data supplied through the input/output circuit 10 and the image processing circuit 11. The confidential circuit 12a of the present embodiment is realized by a volatile and programmable FPGA (Field. Programmable Gate Array). The confidential circuit 12a realized by the FPGA achieves a desired function by changing connections of AND gate, OR gate, and other gates in accordance with a program stored in the volatile memory 12b. The confidential circuit 12a will be described in detail later.

The volatile memory 12b is a storage area of a program for realizing the function of the confidential circuit 12a. The volatile memory 12b is realized by RAM (Random Access Memory), for example. The volatile memory 12b of the present embodiment is realized by a volatile and rewritable SRAM (static random access memory). Thus, the program is stored in the volatile memory 12b, which eliminates unauthorized acquirement of the program by reverse engineering.

The decryption section 13 includes the decryption circuit 13a and an OTP (one time programmable ROM) (programmable ROM, one time programmable ROM, key data writing area) 13b. The decryption section 13, which is a combination of the decryption circuit 13a and the OTP 13b, decrypts the program stored in the nonvolatile memory 9.

The decryption circuit 13a is provided on the side of a download part to the FPGA area (confidential circuit 12a) in the ASIC 8.

The OTP 13b, which is a part of the decryption section 13, is later-writable and unreadable PROM (programmable read only memory). An example of such a one time PROM includes PROM that is programmed by blowing fuses. To the OTP 13b, circuit data (key data) is written, by means of an OTPROM writing circuit 20, by a manufacturer of the image forming apparatus 1. This attains a desired decryption section 13.

The hash function circuit 14 functions as a check section for creating check data from program data provided to the ASIC 8. More specifically, the hash function circuit 14, which is a unidirectional hash function circuit, creates a checksum. The checksum is, for example, a CRC for error correction. Note that, what the hash function circuit 14 creates and outputs is a mere checksum, and the hash function circuit 14 does not output a program itself. Therefore, an internal algorithm (program) is never figured out from output of the hash function circuit 14. A checksum created from input data is matched against a previously computed checksum. A match indicates that the original input data has not been changed.

In the ASIC 8 of the present embodiment, the input/output circuit 10, the image processing circuit 11, the decryption circuit 13a, and the hash function circuit 14 are nonvolatile fixed logic circuits. In these fixed logic circuits, not-specially-secret processing is performed. Note that, in the present embodiment, in order to make it difficult to determine what part corresponds to what circuit of the fixed logic circuits of the ASIC 8, the ASIC 8 has a circuit layout in which the circuits are disposed in a mixed manner.

The following will describe how the above-described image processing section 6 operates to output, to the control section 2, the detection signal indicating whether incoming image data is derived from the specific document.

First, when the operation section 3 detects a power-on operation, the input/output circuit 10 instructs the decryption section 13 to retrieve data from the nonvolatile memory 9 in response to an instruction from the control section 2. The decryption section 13 retrieves data from the nonvolatile memory 9 and decrypts the retrieved data so as to store the decrypted data in the volatile memory 12b.

Here, the decryption section 13 outputs the decrypted program to the hash function circuit 14. The hash function circuit 14 creates a checksum from the received program. Output from the hash function circuit 14 is supplied to the control section 2 so that in the control section 2 the created checksum is matched against a previously computed checksum stored in the storage section 4. If there is a match, it is judged that the program stored in the nonvolatile memory 9 is a proper program, and the process proceeds. On the other hand, if there is no match, it is judged that at least one of programs stored in the nonvolatile memory 9, the decryption circuit 13a, and the OTP 13b is not a proper program, and the process is stopped.

Thereafter, the user performs copying of a document. Copying of the document in the image forming apparatus 1 is performed in the following manner: an image of the document is read by the image reading section 5, the read image is subjected to image processing by the image processing section 6 in accordance with an instruction detected by the operation section 3, and a copied image is formed on a sheet by the image forming section 7.

In copying the document, image data read by the image reading section 5 is fed to the input/output circuit 10 of the ASIC 8. In the ASIC 8, the input/output circuit 10 outputs the image data to the image processing circuit 11 and the confidential circuit 12a. The image processing circuit 11 performs image processing such as scaling and reverse in response to a control instruction from the control section 2 based on the instruction detected by the operation section 3. The data subjected to image processing is outputted to the control section 2. The control section 2 waits for receipt of a detection signal from the image processing section 6.

Meanwhile, the confidential circuit 12a determines whether the image data contains an image of the specific document in the image processing. For example, it is determined by pattern matching whether the image data contains a characteristic graphic pattern unique to bills. The confidential circuit 12a outputs a determination result in a form of the detection signal to the input/output circuit 10.

The input/output circuit 10 outputs the detection signal to the outside of the ASIC 8 at a timing shifted from an output timing of the detection signal supplied from the confidential circuit 12a. For example, the input/output circuit 10 outputs the incoming detection signal to the control section 2 after holding for a random period of time. For example, the output timing is delayed by a time longer than an average processing delay time of the image processing circuit 11. In alternative example, the output timing may be delayed by a random time more than twice as long as the average processing delay time. In this manner, what input data has been used to generate the output from the input/output circuit 10 can be hidden. In another alternative example, the input/output circuit 10 may output the detection signal after delaying it until a predetermined timing.

The control section 2, upon receipt of a negative detection signal indicating that the image data contains no specific image, outputs the image data subjected to image processing to the image forming section 7 so as to cause the image forming section 7 to perform printing. On the other hand, the control section 2, upon receipt of a positive detection signal indicating that the image data contains the specific image, displays as such on a display panel (not shown) of the operation section 3 and stops the process.

Thus, in any output timing of the detection signal from the image processing section 6, the control section 2 determines, from a value of the detection signal, whether the image data contains the specific document. On this account, even if the output timing of the detection signal is shifted by the input/output circuit 10, the image forming apparatus 1 performs the same operation as in the case when the output timing is not shifted in terms of results. Therefore, data transfer is properly performed between the image processing section 6 and the control section 2, whereby the image forming apparatus 1 operates properly.

As described above, the input/output circuit 10 can hide, from an entity outside the ASIC 8, whether inputted or outputted data is one from the confidential circuit 12a or other circuit such as the image processing circuit 11. That is, it is possible to makes it difficult to perform unauthorized detection on which signal is the detection signal from the ASIC 8 out of many signals fed to the control section 2. Therefore, by preventing transmission of an improper detection signal from an external entity to the control section 2, it is possible to prevent unauthorized use by using a false signal (a signal disguising as a proper detection signal, i.e. a signal acting like a proper detection signal). In addition, it becomes difficult to analyze input and output to and from the confidential circuit 12a. This can make unauthorized analysis of an internal logic of the confidential circuit 12a difficult.

A program to be stored in the volatile memory 12b is stored in a storage device provided separately from the ASIC 8. For example, the encrypted program is stored in the nonvolatile memory 9, which is realized by ROM (Read Only Memory) or the like, provided separately from the ASIC 8. This makes it possible to keep the program a secret to a manufacturer of the ASIC 8, thereby preventing leakage of information for realizing the function. Further, thus, separation of the ASIC 8 from the nonvolatile memory 9 can prevent unauthorized analysis of an algorithm for the processing in the ASIC 8 even if, for example, manufacture of the ASIC 8 is ordered to one manufacturer (ASIC vender) B, and manufacture of the nonvolatile memory 9 is ordered to another manufacturer (ROM maker) C.

Further, a decryption circuit for decrypting the encrypted program requires later writing of key data. Therefore, decryption algorithm cannot be figured out from view of the decryption circuit, thus being kept a secret.

Further, a key is one time programmable. That is, the key is an one-time-only writable key. With the arrangement in which this key is written by, for example, a manufacturer (maker) of the image forming apparatus 1, it is possible to prevent unauthorized use of the decryption circuit.

Note that, an arrangement for hiding an internal processing from the outside is not limited to an arrangement using the input/output circuit 10 that delays a timing. For example, provision of a circuit which performs some processing, as the input/output section, makes it difficult to figure out the internal algorithm in a black-box manner. That is, it becomes difficult to figure out details of the processing in an internal secret circuit from output, like the detection signal, obtained from input of data, like the image data, for example. In this case, increase in the number of steps in the internal processing makes it extremely difficult to figure out the internal algorithm from the output. On the contrary, such an input/output section was not conventionally provided, so that the internal algorithm could be figured out by unauthorized access between the control section and the internal confidential circuit.

Here, the input/output circuit 10, for example, may be arranged so as to encrypt the detection signal (block encryption). Thus, encryption of the detection signal for output to the control section 2 allows for hiding of the processing in the confidential circuit 12a. In this case, the control section 2 requires a decrypting function. Further, for example, the input/output circuit 10 may be arranged so as to mix the detection signal with dummy data for output.

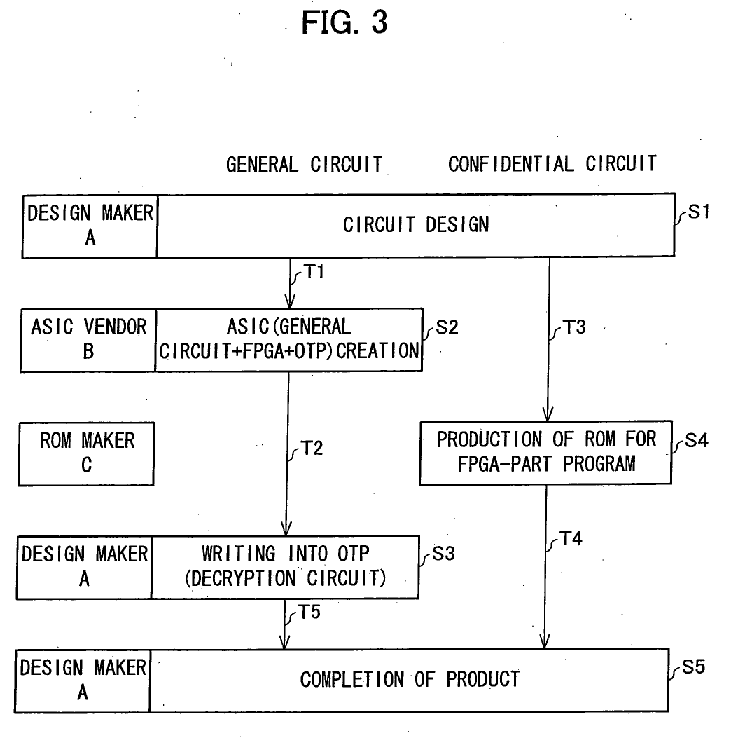

Next, one example of a manufacturing process of the aforementioned image processing section 6 will be described with reference to FIGS. 2 and 3.

As illustrated in FIG. 2, a design maker A commissions manufacture of the ASIC 8 to an ASIC vendor B (T1: release of the general circuit). At this stage, the design maker A commissions the ASIC vendor B to manufacture the ASIC 8 which is designed to include the confidential circuit 12a provided as a programmable FPGA area. In addition, the decryption circuit 13 for the confidential circuit 12a is designed to include the OTP 13b that is subjected to later writing.

The ASIC vendor B manufactures the ASIC 8 and then delivers it to the design maker A (T2: ASIC (FPGA+OTP) delivery).

Meanwhile, the design maker A commissions, to a ROM maker C, manufacture of ROM (nonvolatile memory 9) storing an encrypted program for the FPGA area of the ASIC 8 (T3: release of the encrypted FPGA program). The ROM maker C manufactures ROM storing the encrypted program and then delivers it to the design maker A (T4: ROM delivery).

The following is an explanation with reference to FIG. 3: in S1, the design maker A performs a circuit design of the ASIC 8 and the nonvolatile memory 9 for the image processing section 6. The design maker A offers a circuit diagram of the designed ASIC 8 to the ASIC vendor B (T1), and offers a circuit diagram of the designed nonvolatile memory 9 to the ROM maker C (T3).

The ASIC vendor B designs the ASIC 8 in accordance with a received circuit diagram (S2), and delivers a completed product to the design maker A (T2). The ROM maker C produces ROM (nonvolatile memory 9) in accordance with a received circuit diagram (S4), and delivers a completed product to the design maker A (T4).

The design maker A writes key data into the OTP 13b of the ASIC 8 received from the ASIC vendor B (S3), and then packages the ASIC 8 and the ROM 9 into one unit that is the image processing section 6 as a product (S5).

Thus, the content (layout for the program) of the confidential circuit 12a is not released to the ASIC vendor B, so that it can be kept a secret. Moreover, manufacture of the ASIC 8 arranged such that the decryption circuit 13a is combined with the OTP 13b is commissioned to the ASIC vendor B, so that the ASIC vendor 8 never knows the content of the decryption circuit 13a.

In addition, as to the program for the confidential circuit 12a (FPGA area), which is written into the ROM (nonvolatile memory 9), manufacture of the ROM is commissioned to the ROM maker C after the program has been encrypted, so that the ROM maker C never knows the program, thus ensuring security. This makes it hard to determine what part of data corresponds to data of the FPGA area circuit.

Further, the design maker A performs writing into the OTP 13b, so that the ASIC vendor B and the ROM maker C never know details of the decryption section 13 having the decryption circuit 13a and the OTP 13b combined together. Note that, if the decryption section 13 is not arranged such that writing into the OTP 13b is later performed for completion of the decryption section 13, a diagram of the entire decryption section 13 is released to the ASIC vender B. Therefore, an algorithm of the decryption section 13 might be known to the ASIC vendor B.

Note that, an arrangement of the ASIC 8 as a semiconductor device is not limited to the above-described arrangement. As to the ASIC 8, the above descriptions have been given based on the arrangement in which the decryption circuit 13a is provided as a fixed logic circuit. However, the present invention is not limited to this. For example, the decryption circuit 13a may also be arranged so as to be writable. That is, the decryption circuit 13a as well as the OTP 13b may be provided as FPGA. Thus, if writing to the decryption circuit 13a as well as the OTP 13b as a key is performed by the maker, the arrangement of the decryption section 13 is not leaked to a commission manufacturer of the ASIC 8. Note that, to make the decryption circuit 13a writable, a rewritable ROM such as EEPROM is not used.

The ASIC 8 and the nonvolatile memory 9 may be arranged as follows.

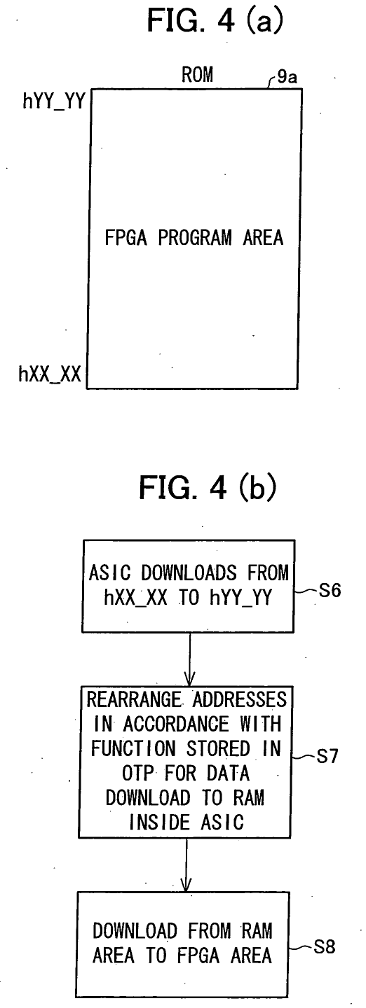

Referring to FIGS. 4(a) and 4(b), the following will describe one example of an arrangement which makes it difficult to analyze the confidential circuit 12a using ROM 9a as one example of the nonvolatile memory 9 illustrated in FIG. 1.

In the present variation, a program to be stored in the ROM 9a is subjected to address rearrangement. As illustrated in FIG. 4(a), addresses hXX_XX to hYY_YY of the ROM 9a indicate a FPGA program area that stores a FPGA program for the confidential circuit 12a.

The following will describe an operation at the time of loading the program stored in the ROM 9a into the ASIC 8.

First, as shown in S6 of FIG. 4(b), the input/output circuit 10, in response to a program download instruction given from the CPU functioning as the control section 2, acquires the addresses hXX_XX to hYY_YY of the ROM 9a and sends them to the decryption section 13.

In S7, the decryption circuit 13a and the OTP 13b, as the decryption section 13, decrypts the downloaded program in accordance with a predetermined procedure. Here, addresses are rearranged in accordance with a function stored in the OTP 13b. As a result of this, data are rearranged. As the function, an inverse function of the function used in the ROM 9a can be used. This realizes decryption of the program. Thereafter, the decrypted program is downloaded to RAM as one example of the volatile memory 12b illustrated in FIG. 1.

In S8, the program is downloaded from the volatile memory 12b to the confidential circuit 12a that is a FPGA. This provides the functionality in the confidential circuit 12a, so that the confidential circuit 12a operates in accordance with the FPGA program.

Note that, as one example of address rearrangement function, change of places between a highmost address and a undermost address can be considered. Corresponding to this function, program data having a changed address sequence is stored in advance in the ROM 9a.

In the example that has been described above, a program stored in the nonvolatile memory 9 is a rearranged program, not a real program itself, so that it is possible to prevent the functionality of the confidential circuit 12a from being identified by reading the program. Further, decryption of the program is performed in the decryption section 13 including the later-written OTP 13b, so that it is possible to prevent analysis of a decryption algorithm.

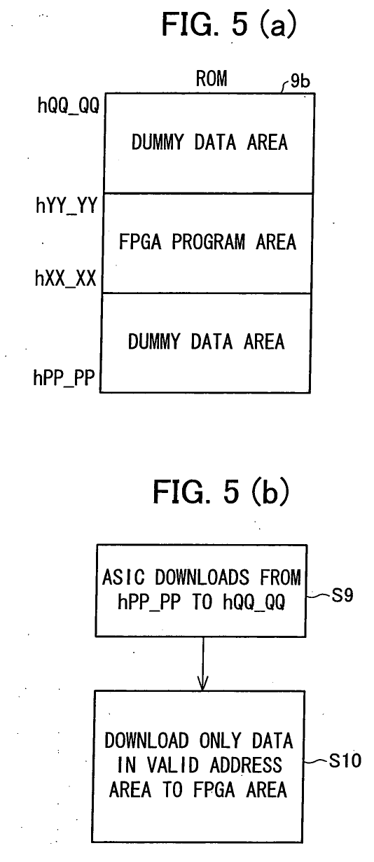

Next, referring to FIGS. 5(a) and 5(b), the following will describe one example of an arrangement which makes it difficult to analyze the confidential circuit 12a using ROM 9b as one example of the nonvolatile memory 9 illustrated in FIG. 1. In the present variation, the ROM 9b storage capacity of which is larger than a total amount of data downloaded to the FPGA has valid data area in part thereof and dummy data area in the other part thereof. From among data supplied from the input/output circuit 10 of the ASIC 8, the decryption section 13 selects only the valid data area, which has been originally set in the circuit, for downloading.

As illustrated in FIG. 5(a), the FPGA program for the confidential circuit 12a is stored in the ROM 9b at the addresses hXX_XX to hYY_YY. Further, dummy data is stored in the ROM 9b at addresses hPP_PP to hXX_XX and addresses hYY_YY to hQQ_QQ (dummy data areas).

The following will describe an operation at the time of loading the program stored in the ROM 9b into the ASIC 8.

First, from the CPU functioning as the control section 2, a download instruction is provided to the input/output circuit 10. As shown in S9 of FIG. 5(b), the input/output circuit 10, in response to this instruction, downloads addresses hPP_PP to hQQ_QQ of the ROM 9b to the decryption section 13. The input/output circuit 10 instructs to download valid data together with the dummy data areas.

In S10, the decryption circuit 13a and the OTP 13b, as the decryption section 13, decrypts the downloaded program in accordance with a predetermined procedure. Here, only data at the predetermined addresses (addresses hXX_XX to hYY_YY) are extracted in accordance with the content stored in the OTP 13b. This realizes decryption of the program. Thereafter, the decrypted program is downloaded to RAM as one example of the volatile memory 12b illustrated in FIG. 1. Then, the decrypted program is downloaded from the volatile memory 12b to the confidential circuit 12a that is a FPGA. This provides the functionality in the confidential circuit 12a, so that the confidential circuit 12a operates in accordance with the FPGA program.

Thus, incorporation of dummy data into the program stored in the nonvolatile memory 9 also makes it difficult to identify the functionality of the confidential circuit 12a by unauthorized reading of the program. Further, decryption of the program is performed in the decryption section 13 including the later-written OTP 13b, so that it is possible to prevent analysis of a decryption algorithm.

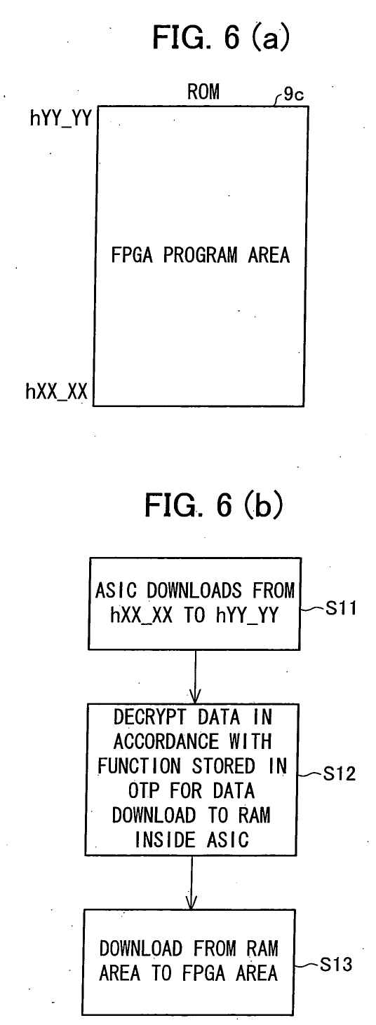

Next, referring to FIGS. 6(a) and 6(b), the following will describe one example of an arrangement which makes it difficult to analyze the confidential circuit 12a using ROM 9c as one example of the nonvolatile memory 9 illustrated in FIG. 1.

In the present variation, the program is subjected to compression coding for storage in the ROM 9c. As a compression coding method, JBIG compression is adopted, for example. In the JBIG compression, binary bits are rearranged in a random manner. The compression coding, which enables generation of other data from original data itself of the program, can be regarded as a kind of encryption.

As illustrated in FIG. 6(a), the FPGA program for the confidential circuit 12a is subjected to compression coding for storage in the ROM 9c at addresses hXX_XX to hYY_YY.

The following will describe an operation at the time of loading the program stored in the ROM9c into the ASIC 8.

First, from the CPU functioning as the control section 2, a download instruction is provided to the input/output circuit 10. As shown in S11 of FIG. 6(b), the input/output circuit 10, in response to this instruction, downloads addresses hXX_XX to hYY_YY of the ROM 9b to the decryption section 13.

In S12, the decryption circuit 13a and the OTP 13b, as the decryption section 13, decrypts the downloaded program using an inverse function of the compression coding in accordance with a predetermined procedure. Thereafter, the decrypted program is downloaded into RAM as one example of the volatile memory 12b illustrated in FIG. 1. Then, in S13, the decrypted program is downloaded from the volatile memory 12b to the confidential circuit 12a that is a FPGA. This provides the functionality in the confidential circuit 12a, so that the confidential circuit 12a operates in accordance with the FPGA program.

Thus, encryption of the program stored in the nonvolatile memory 9 allows for preventing the functionality of the confidential circuit 12a from being identified by reading the program. Decryption of the program is performed in the decryption section 13 including the later-written OTP 13b, so that analysis of decryption algorithm can be prevented.

Note that, the compression coding has been taken as one example of encryption method. However, the encryption method is not limited to this. As an algorithm of a function for encryption, a normal, so-called encryption algorithm, such as DES, may be used. Alternatively, encryption may be performed by rearrangement of data bits.

Moreover, combinations of the variations to the aforesaid input and output can be adopted. That is, any of the followings (A) through (E) may be combined: (A) encryption by address rearrangement; (B) encryption by dummy data incorporation; (C) so-called encryption (block encryption); (D) encryption by data bits rearrangement; and (E) compression coding. Combination of the encryption methods in this manner can make unauthorized decryption of the program difficult.

In this case, the decryption section 13, realized by the decryption circuit 13a and the OTP 13b, is provided with selectable decryption units for performing decryptions with respect to (A) address rearrangement; (B) dummy data; (C) normal encryption; (D) data bits rearrangement; and/or (E) compression coding. In response to an instruction from the input/output circuit (switch), the decryption units are switched.

An example of a method for switching between decryption methods in the decryption section 13 is as follows: a circuit for switching between the decryption methods in accordance with unique information to the ASIC 8, such as last number of serial machine numbers, is incorporated into the OTP 13b; a program obtained by combination of the encryption methods is stored in the nonvolatile memory 9; and the decryption section 13 performs decryptions in reverse order to the order in which the encryption methods are combined.

The order of encryptions is not particularly limited. For example, encryptions may be performed in the order of (A), (B), (C), (D), and (E), and alternatively, in the order of (A), (C), (B), . . . etc. or in the order of (B), (A), (C), . . . etc. The number of times the same encryption method is performed is not limited to one, and the same encryption method may be performed at any number of times. For example, encryptions may be performed in the order of (A), (B), (C), (D), (E), (A), and (B) . . . etc.

Further, in the foregoing variations to the program input and output, combination of the encryption methods has been described. However, the present invention is not limited to this. For example, the states of input and output of the program are hidden from an entity outside the ASIC 8 by shifting a timing of program input to the ASIC 8, so that it is possible to make unauthorized analysis of the confidential circuit 12a difficult.

The following will describe an arrangement in which a program stored in the nonvolatile memory 9 is downloaded at a timing except for a timing of power-on of the image forming apparatus 1.

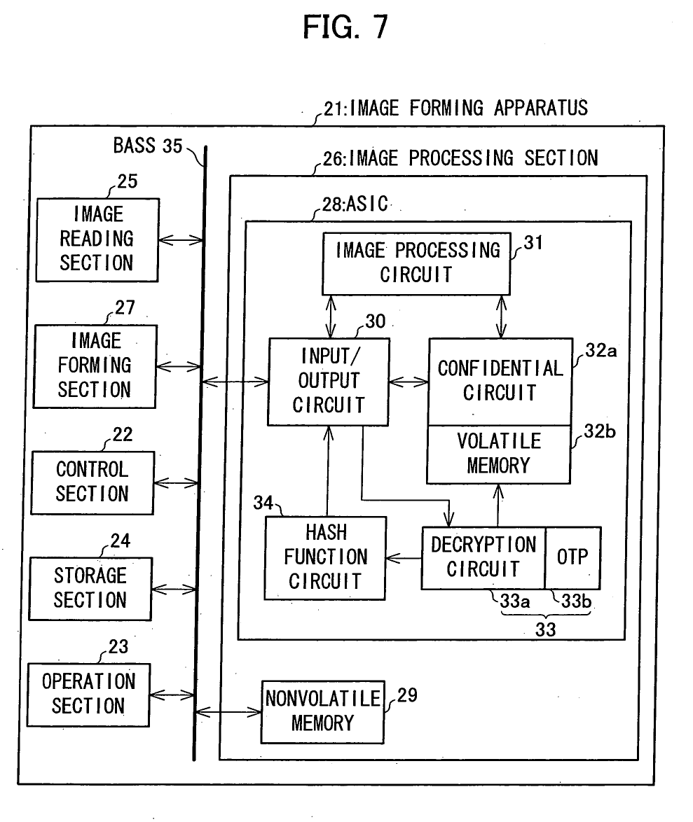

An image forming apparatus (electronic apparatus) 21 of the present variation, as illustrated in FIG. 7, is provided with a control section 22, an operation section 23, a storage section 24, an image reading section 25, an image processing section (semiconductor device) 26, and an image forming section 27.

The image processing section 26 includes an ASIC (semiconductor device) 28 and a nonvolatile memory (storage device) 29. The ASIC 28 is provided with an input/output circuit (input/output section) 30, an image processing circuit 31, a confidential circuit (programmable circuit) 32a, a volatile memory 32b, a decryption section 33, and a hash function circuit (unidirectional hash function section) 34.

In the image forming apparatus 21, components provided therein are connected to one another through a bus. The control section 22, the ASIC 28, and the nonvolatile memory 29 are connected to one another through a bus. On this account, downloading from the nonvolatile memory 29 to the ASIC 28 is performed with the same interface as an interface used by the control section 22. In this point, the image forming apparatus 21 is different from the image forming apparatus 1 illustrated in FIG. 1. Note that, the components given reference numerals 22 through 34 illustrated in FIG. 7 have substantially the same functions as the components given reference numerals 2 through 14 included in the image forming apparatus 1 illustrated in FIG. 1, and explanations thereof are omitted here except where explanations otherwise requires.

The image forming apparatus 21 performs loading of a program stored in the nonvolatile memory 29 at the time of detection of a copying request after the power-on of the image forming apparatus 21, not at the time of power-on of the image forming apparatus 21. More specifically, the control section 22 instructs the input/output circuit 30 of the ASIC 28 to load the program. In the ASIC 28, the input/output circuit 30 acquires data for supply of the incoming data. The input/output circuit 30 reads, through a bus 35, the program stored in the nonvolatile memory 29. The input/output circuit 30 outputs the acquired program to the decryption section 33. The decryption section 33 decrypts the program and then causes the volatile memory 32b to store the decrypted program.

In this manner, loading of the program is carried out at a timing after the power-on, not at the timing of the power-on, so that downloading from the nonvolatile memory 29 to the ASIC 28 can be camouflaged by supply of data from the control section 22 to other component. This makes it possible to make unauthorized analysis difficult, thus hiding from an entity outside the ASIC 28 input and output to and from the confidential circuit 32a of the ASIC 28. Loading of the program is performed before the use of the confidential circuit 32a. Loading of the program may be performed after start of the input and output to and from the image processing circuit 33. Alternatively, loading of the program may be performed after a predetermined time lapsed from a power-on.

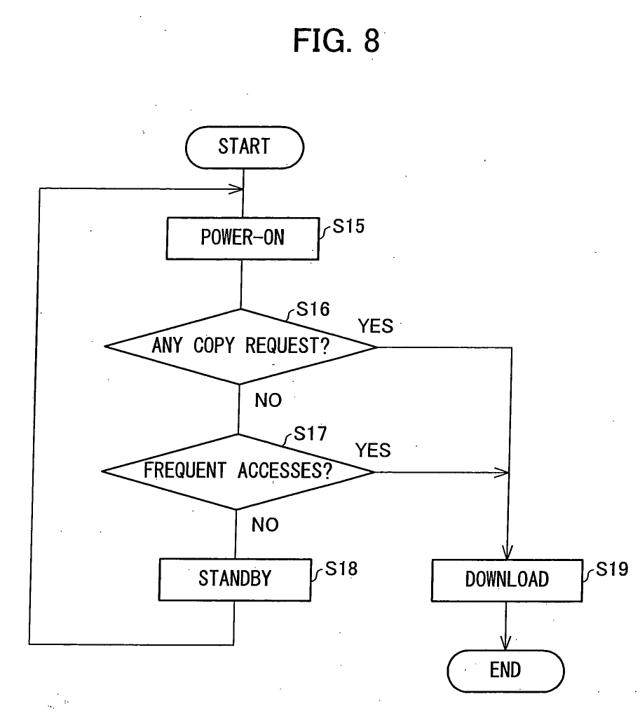

The following will describe one example of how the image processing section 26 of the image forming apparatus 21 performs loading of the program with reference to FIG. 8.

In S15, upon detection of a power-on instruction to the operation section 23 of the image forming apparatus 21, the control section 22 turns on the power of the image forming apparatus 21. In S16, the control section 22 judges whether a copy request has been made to the operation section 23.

In S16, if it is judged that the copy request has been made, the process goes to S19. In S19, the program is load into the ASIC 28 from the nonvolatile memory 29 through the bus 35, and then the process is finished. Downloading is not performed at the time of power-on, thus being camouflaged by other data transfer. In S16, if it is judged that the copy request has not been made, the process goes to S17.

In S17, the control section 22 judges whether frequent internal or external accesses occur due to data transmissions and receptions through the bus 35. Specifically, on the occasion of transmission and reception of data through the bus 35 in the form of a packet, the control section 22 judges whether the probability of occurrence of packet collision is a predetermined value or more. In S17, if frequent accesses occur, the process goes to S19. In S19, the input/output circuit 30, in response to an instruction from the control section 22, downloads the program, and the process is finished. Thus, in case of downloading during frequent accesses, the downloading can be camouflaged by other data transfer, thus making unauthorized analysis more difficult. In S17, if frequent accesses do not occur, the process goes to S18 to enter a download standby state, and then goes back to S16.

As described above, for example, as in the case of the confidential circuit 32a used for specific document determination at the time of copying, when a timing of using an image identifying function of the confidential circuit 32a is much later than the timing of power-on, a timing of downloading the program for the confidential circuit 32a is delayed. Then, through the bus 35, which is shared with the control section 22, a program is downloaded under cover of accesses from the control section 22 to the ASIC 28. In this manner, even when the bus 35 is subjected to unauthorized substrate waveform analysis on data input and output to and from the ASIC 28, a content of the program is not identified. On the contrary, in a normal and general arrangement, a program for FPGA such as a confidential circuit is downloaded at the time of power-on of the apparatus, so that a content of the program could be identified by unauthorized substrate waveform analysis.

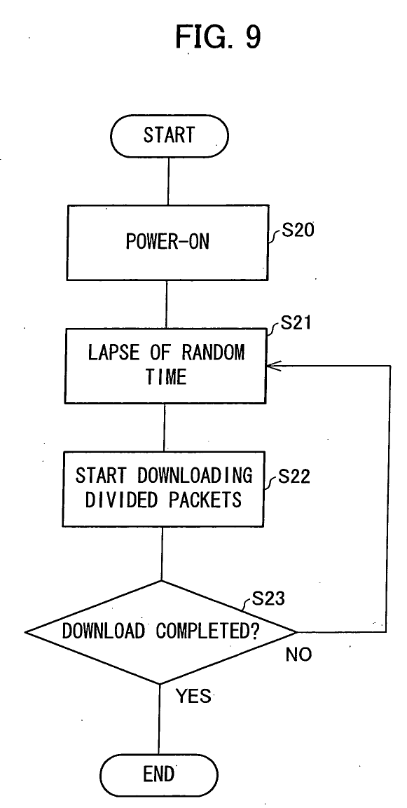

Next, referring to FIG. 9, the following will describe another variation where timings of program input and output are shifted in the image forming apparatus 21. In this variation, a program to be loaded is divided into packets, and the packets are downloaded at random timings, so that loading of the program is camouflaged by other data transfer.

In S20, upon detection of a power-on instruction to the operation section 23 of the image forming apparatus 21, the control section 22 turns on the power of the image forming apparatus 21. In S21, the input/output circuit 30 waits for a lapse of a randomly determined time, and then the process goes to S22.

In S22, the input/output circuit 30 loads data into which the program stored in the nonvolatile memory 29 has been divided, in the form of packets, through the bus 35. In S23, the input/output circuit 30 judges whether all the divided data have been downloaded. If it is judged that there still remains any data that has not been downloaded yet, the process goes back to S21 to wait for a random time, and thereafter next data is downloaded in the form of a packet in S22. In S23, if it is judged that all the data have been downloaded, the process is finished.

According to the foregoing process, the divided data are sequentially downloaded in the form of packets at random timings, so that downloading of the data is performed under cover of other data transfer, thus making unauthorized decryption of the program difficult.

Thus, data to be downloaded is divided into packets or the like in predetermined units, so that they are downloaded under cover of accesses from the control section 22 to the ASIC 28. The decrypted data is stored in the volatile memory 32b of the ASIC 28. Here, if data are downloaded at random time intervals, it is possible to make program identification by unauthorized reading more difficult. Further, the packets into which data to be downloaded are divided may be of random sizes. Note that, as in the normal and general arrangement, when the program is downloaded by sequential transmissions and receptions of packets, the content of the program could be identified by unauthorized substrate waveform analysis.

Further, program loading operation performed by the image processing section 26 of the image forming apparatus 21 is not limited to the foregoing operation. For example, in order to perform program loading operation under cover of accesses from the control section 22 to the ASIC 28, the control section 22 may perform dummy write and dummy access to the ASIC 28 in response to an instruction from the input/output circuit 30. In this manner, downloading of the program is performed under cover of dummy access from the control section 2, thus making unauthorized analysis difficult.

Note that, on the basis of the image forming apparatus 21 and the image processing section 26 illustrated in FIG. 7, the operation of loading a program through the input/output circuit 30 with a shared use of the bus 35, which is used by the control section 22, have been described above. However, the present invention is not limited to this arrangement.

For example, as illustrated in FIG. 1, the image processing section 6 and the image forming apparatus 1 may be arranged such that the ASIC 8 and the nonvolatile memory 9 are directly connected to each other for data transfers. In this arrangement, the ASIC 8 may include a transfer control section for controlling data transfer between the nonvolatile memory 9 and the ASIC 8. However, this arrangement makes it difficult to download a program under cover of other data transfer since the connection between the ASIC 8 and the nonvolatile memory 9 is one-to-one direct connection. This arises the possibility that a transfer timing of the program could be subjected to unauthorized detection.

Further, the image forming apparatus 1 illustrated in FIG. 1 and the image forming apparatus 21 illustrated in FIG. 7 each may have one decryption circuit. However, the present invention is not limited to this. They may be image forming apparatuses having a plurality of decryption circuits.

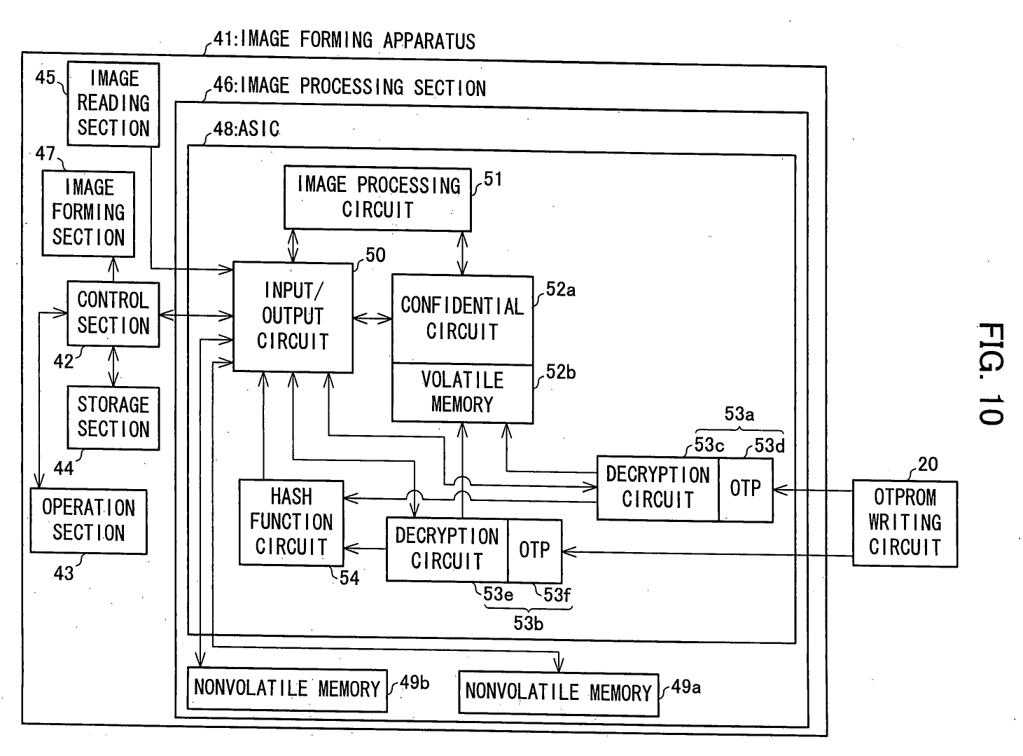

The image forming apparatus (electronic apparatus) 41 of the present variation, as illustrated in FIG. 10, is provided with a control section 42, an operation section 43, a storage section 44, an image reading section 45, an image processing section (semiconductor device) 46, and an image forming section 47.

Further, the image processing section 46 includes an ASIC (semiconductor device) 48 and a nonvolatile memories (storage devices) 49a and 49b. The ASIC 48 is provided with an input/output circuit (input/output section, switch) 50, an image processing circuit 51, a confidential circuit (programmable circuit) 52a, a volatile memory 52b, decryption sections 53a and 53b, and a hash function circuit (unidirectional hash function section) 54. The decryption section 53a is composed of a decryption circuit 53c and an OTP (programmable ROM, one time programmable ROM, key data writing area) 53d. The decryption section 53b is composed of a decryption circuit 53e and an OTP (programmable ROM, one time programmable ROM, key data writing area) 53f.

The image processing section 46 of the present embodiment is different from the image processing sections of the foregoing embodiments in that the image processing section 46 includes a plurality of the decryption sections 53a and 53b and a plurality of the nonvolatile memories 49a and 49b. Note that, components given reference numerals 42 through 54 illustrated in FIG. 10 have substantially the same functions as the components given reference numerals 2 through 14 included in the image forming apparatus 1 illustrated in FIG. 1, and explanations thereof are omitted here except where explanations otherwise requires.

In the above-arranged image processing section 46, the input/output circuit 50 performs loading of a program from the nonvolatile memories 49a and 49b and then outputs the acquired program to the independently provided decryption sections 53a and 53b. A timing of access to the nonvolatile memories 49a and 49b by the input/output circuit 50 can be arbitrarily determined. For example, the program may be loaded at a shifted timing as described earlier. Alternatively, the program may be loaded at random time intervals. The decryption sections 53a and 53b download the decrypted program to the volatile memory 52b. Then, the program is downloaded from the volatile memory 52b to the confidential circuit 52a, which causes the confidential circuit 52a to function.

Thus, in a case where a plurality of interfaces are provided in the ASIC 48, loading of a program through the interfaces can make unauthorized analysis difficult.

As described above, the present invention relates to an ASIC incorporating a programmable circuit such as a FPGA. More specifically, the present invention relates to hiding of a program stored in the FPGA section. The foregoing semiconductor device, which is an ASIC incorporating a FPGA (programmable circuit), is arranged so as to include an interface to external entity to be processed as a fixed circuit and a decryption section of an encrypted FPGA program. This arrangement offers an ASIC which can hide the processing of a programmable circuit in a black-box manner. Further, this arrangement offers an ASIC circuit configuration which provides, as FPGA in an ASIC, a confidential circuit (bill tracing/recognition circuit or the like) that is undesired to be known to outsiders including the ASIC vendor, and can make it difficult to analyze a content of the confidential circuit in the FPGA area even if a substrate of a product is subjected to waveform analysis.

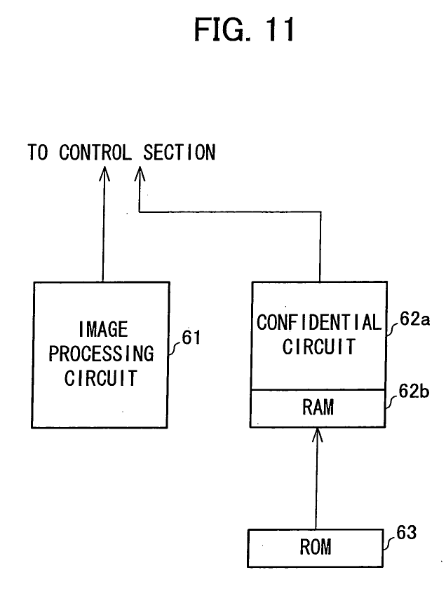

Here, conventionally, as illustrated in FIG. 11, in the image processing section, an image processing circuit 61, a confidential circuit 62a, RAM 62b, and ROM 63 were all exposed, so that it was possible to easily detect input and output of the circuits. Therefore, there was the problem that when image data was supplied, in this state, for detection of a response to the image data, what kind of feature in the image data was recognized was figured out.

Here, as conventional art, there are the following arrangements: (1) an arrangement in which a confidential circuit is incorporated in an ASIC; (2) an arrangement in which a confidential circuit is provided in an external FPGA and a copy protection section is provided; (3) an arrangement in which all the circuits including a confidential circuit are provided as FPGAs; (4) an arrangement in which only a confidential circuit provided as FPGA and an ASIC including the other circuits are integrated into one chip; and other arrangements.

The arrangement (1) has further the following problem. First, in order to provide the confidential circuit as an ASIC, at least a diagram of a gate level circuit must be released to the ASIC vendor. Theoretically, from such a gate level circuit, it is possible to figure out a circuit source by decompilation. In addition, a diagram of a delivery inspection-use test pattern including the confidential circuit must be released to the ASIC vendor. This gives information on a probable circuit to the ASIC vendor. Note that, if the test pattern diagram is not released, there could occur decrease in fault detection rate and increase in percent defective of mass-produced ASICs.

The arrangement (2) is an arrangement such that an ASIC, a general circuit, includes an external FPGA provided with the confidential circuit on a substrate system. In this arrangement, for example, as described in the patent documents 2 and 3, even if copy of the FPGA is protected by key data matching that performs matching of a response sequence, circuit operation and contents could be figured out by analysis of an external terminal of the FPGA, which is exposed at the time of its actual operation on a substrate of a product. Further, downloading of the FPGA is generally performed upon power-on. Because of this, the downloaded data upon power-on might be analyzed.

In the arrangement (3), mass production of a large-scale circuit such as a system chip by using a FPGA is not realistic since a large-scale FPGA capable of high speed performance is currently very expensive.

As in the case of the arrangement (4), a simple arrangement can be considered such that only a confidential circuit provided as FPGA and an ASIC including the other circuits are integrated into one chip. However, the vender can figure out a configuration of circuits around the FPGA from a diagram of gates released from a client. Moreover, a vendor-designed FPGA suffers circuit analysis of a confidential part by analysis of downloaded data to the FPGA, such as waveform observation of a substrate of a product, or other method. Further, information about the same FPGA design are distributed to other clients who have commissioned a certain vendor to design the FPGA, so that there is the possibility that the circuit could be figured out from ROM data.

A semiconductor device according to the present invention is, in the above arrangement, preferably such that the input/output section outputs data from the semiconductor device at a timing shifted from a timing of output from the programmable circuit, so as to hide input and output of data from an entity outside the semiconductor device.

The input/output section shifts a timing of data output by delaying it, for example. Thus, shift of the timing by the input/output section allows data output to be hidden.

In the above arrangement, the input/output section may be arranged so as to perform output from the programmable circuit after receipt of other data in the semiconductor device. With this arrangement, it is possible to hide data output by acting like an output in response to the received other data.

A semiconductor device according to the present invention, in the above arrangement, is preferably such that the input/output section performs output at a timing randomly shifted from an output timing of data from the programmable circuit.

In this manner, randomly shifted timing of data output makes it possible to hide what input has been used to generate the output.

In addition, in the above arrangement, for example, the output timing is delayed by a time longer than an average processing delay time. In alternative example, the output timing may be delayed by a random time more than twice as long as the average processing delay time. In this manner, what input data has been used to generate the output can be hidden.

A semiconductor device according to the present invention, in the above arrangement, is preferably such that the input/output section encrypts an output from the programmable circuit for output from the semiconductor device, so as to hide input and output of data from an entity outside the semiconductor device.

The input/output section performs encryption, so that it is possible to hide data output. In this case, a receiver of the output from the input/output section performs decryption.

A semiconductor device according to the present invention, in the above arrangement, is preferably such that the programmable circuit is a volatile programmable circuit, and the input/output section acquires program data of the programmable circuit from an entity outside the semiconductor device at a timing except for power-on of an electronic apparatus provided with the semiconductor device, so as to hide input and output of data from an entity outside the semiconductor device.

The volatile programmable circuit is a SRAM (static random access memory) rewritable circuit.

The input/output section of the semiconductor device makes access to a storage device outside the semiconductor device so as to acquire program data stored in the storage device. Receipt of the program data can be hidden, so that it becomes difficult to perform unauthorized analysis of an algorithm processed in the programmable circuit.

Normally, it is expected to acquire the program data upon power-on.

In view of this, as in the above arrangement, if the program data is acquired at a timing except for power-on, it becomes difficult to perform unauthorized acquisition between the semiconductor device and the storage device storing the program data even if an unauthorized acquisition attempt takes place.

Further, in the above arrangement, the input/output section may be arranged so as to acquire program data before the use of the programmable circuit. Still further, in the above arrangement, the input/output section may be arranged so as to acquire program data after the start of input and output from the fixed logic circuit. Yet further, in the above arrangement, the input/output section may be arranged so as to acquire program data after a predetermined time lapsed from power-on.

In addition, the foregoing semiconductor device can be expressed as a semiconductor device having an arrangement in which a program supply is performed at a timing that is not a timing of power-on.

A semiconductor device according to the present invention, in the above arrangement, is preferably such that the input/output section acquires the program data divided into multiple pieces.

Thus, since the input/output section acquires the program data in the form of divided pieces of data, it is possible to prevent unauthorized acquisition by making it difficult to identify the program data even if an unauthorized acquisition attempt takes place.

Further, the foregoing semiconductor device can be expressed as a semiconductor device having an arrangement in which communications are performed several times for a program supply.

A semiconductor device according to the present invention, in the above arrangement, is preferably such that the input/output section acquires the program data divided into pieces of random sizes.

Divided pieces of the program data are of random sizes, so that it becomes more difficult to identify the program data.

Still further, the foregoing semiconductor device can be expressed as a semiconductor device having an arrangement in which divided communications make data packet sizes random.

A semiconductor device according to the present invention, in the above arrangement, is preferably such that the input/output section acquires the program data divided into multiple pieces at random time intervals.

Since the program data is acquired at random time intervals, it becomes difficult to identify the program data.

Yet further, the foregoing semiconductor device can be expressed as a semiconductor device having an arrangement in which divided communications make communication intervals random.

A semiconductor device according to the present invention, in the above arrangement, is preferably such that the input/output section has a plural of interfaces for acquiring the program data.

Since divided pieces of the program data can be acquired through a plurality of interfaces, it becomes more difficult to identify the program data.

Further, the foregoing semiconductor device can be expressed as a semiconductor device having an arrangement in which divided pieces of the program are supplied through a plurality of interfaces.

A semiconductor device according to the present invention, in the above arrangement, preferably includes a unidirectional hash function section for creating check data from program data of the programmable circuit.

When check data is created from the program data by the unidirectional hash function section, it is possible to easily check about whether the program data is a proper one previously created by comparing with a previously created check data. In addition, the check is possible outside the semiconductor device without loss of confidentiality since the program data itself is not compared.

The semiconductor device according to the present invention, in the above arrangement, is preferably such that the semiconductor device is an image processing section for performing image processing, and the programmable circuit performs recognition of a specific document.

The specific document is a document to be recognized. For example, in the image processing circuit provided in the image forming apparatus, it is assumed that the specific document is a bill. The image processing circuit judges whether a document to be printed is a bill. If so, printing of the document is stopped.

According to the above arrangement, it is possible to hide an algorithm for recognition of the specific document in the image processing circuit.

A semiconductor device according to the present invention, in the above arrangement, preferably includes a decryption section for decrypting encrypted program data of the programmable circuit.

The program data of the programmable circuit is encrypted, so that it becomes difficult to perform algorithm and logic analysis by analysis of the program data.

Further, the foregoing semiconductor device can be expressed as an ASIC having at least (i) a SRAM programmable first circuit and (ii) a second circuit logic of which is fixed even after power-off provided in one integrated circuit, wherein the second circuit is provided with a decryption section for decrypting a previously encrypted program externally supplied to the first circuit and an input/output section for hiding the processing which the first circuit performs in accordance with the program from an entity outside the ASIC. With this arrangement, it becomes difficult to analyze algorithm and logic of the first circuit on the basis of an externally loaded program and operation of ASIC. In addition, the foregoing semiconductor device may be arranged such that the second circuit includes a unidirectional hash function section for creating check data from the program data decrypted and supplied to the first circuit.

A semiconductor device according to the present invention, in the above arrangement, is preferably such that at least part of the decryption section is realized by a programmable ROM that is writable and unreadable from an entity outside the semiconductor device.

Here, an unreadable semiconductor device means a semiconductor device having a one-way buffer holding only incoming data, not holding outgoing data.

Thus, if at least part of the decryption section is realized by a programmable ROM, it is possible to perform later writing into this programmable ROM.

Therefore, at the time of ordering an external maker to manufacture a semiconductor device, the ordering can be performed without informing the external maker of what is written into the programmable ROM. This eliminates the need for informing the external maker of the entire decryption section.

A semiconductor device according to the present invention, in the above arrangement, is preferably such that the programmable ROM is a one time programmable ROM.

The programmable ROM is one-time-only writable ROM. Therefore, there is no possibility that a content of the programmable ROM is figured out by later rewriting of the programmable ROM.

Still further, the foregoing semiconductor device can be expressed as a semiconductor device having an arrangement in which PROM of the decryption section is one time PROM.

A semiconductor device according to the present invention, in the above arrangement, is preferably such that the programmable ROM is provided with a key data writing area that, upon writing of key data into the key data wiring area, causes the decryption section to function for decryption of the program data.

The decryption section of the semiconductor device does not operate if key data is not written into the key data area. Therefore, by properly managing the key data, it is possible to prevent unauthorized use of the semiconductor device.

Yet further, the foregoing semiconductor device can be expressed as a semiconductor device having an arrangement in which at least part of the decryption section is realized by an externally writable and unreadable PROM, and (key) data written into the PROM customizes the decryption section.

A semiconductor device according to the present invention, in the above arrangement, is preferably such that the decryption section decrypts program data encrypted by address manipulation.

The data thus encrypted by address manipulation can be decrypted with simple processing.

Further, the foregoing semiconductor device can be expressed as a semiconductor device having an arrangement in which encryption of the program is address manipulation.

A semiconductor device according to the present invention, in the above arrangement, is preferably such that the decryption section decrypts program data mixed with dummy data.

Thus, when the program data is mixed with dummy data, it becomes difficult to identify the program data.

Still further, the foregoing semiconductor device can be expressed as a semiconductor device having an arrangement in which the program data is supplied together with dummy data at the time of program supply.

A semiconductor device according to the present invention, in the above arrangement, is preferably such that the decryption section decrypts program data subjected to block encryption.

It is possible to enhance encryption by adopting DES (data encryption standard) or AES (advanced encryption standard). In addition, it is easy to convert to hardware.

Yet further, the foregoing semiconductor device can be expressed as a semiconductor device having an arrangement in which encryption of the program is block encryption.

A semiconductor device according to the present invention, in the above arrangement, is preferably such that the decryption section decrypts program data encrypted by rearrangement of data bits.

The data thus encrypted by rearrangement of data bits can be decrypted with simple processing.

Further, the foregoing semiconductor device can be expressed as a semiconductor device having an arrangement in which encryption of the program is rearrangement of data bits.

A semiconductor device according to the present invention, in the above arrangement, is preferably such that the decryption section decrypts program data encrypted by compression coding.

Here, the compression coding is compression such as JBIG method and run-length method.

The data thus encrypted by compression coding can be decrypted with simple processing.

Still further, the foregoing semiconductor device can be expressed as a semiconductor device having an arrangement in which encryption of the program is performed by compression such as JBIG method and run-length method.

A semiconductor device according to the present invention, in the above arrangement, is preferably such that the decryption section has: a first decryption unit for decrypting program data encrypted by address manipulation; a second decryption unit for decrypting program data mixed with dummy data; a third decryption unit for decrypting program data subjected to block encryption; a fourth decryption unit for decrypting program data encrypted by rearrangement of data bits; and a fifth decryption unit for decrypting program data encrypted by compression coding, the input/output section operating as a switch for selecting one for use in a desired order from among the first decryption unit, the second decryption unit, the third decryption unit, the fourth decryption unit, and the fifth decryption unit.

Thus, a combined and selected use of encryption methods can enhance encryption.

Yet further, the foregoing semiconductor device can be expressed as a semiconductor device having an arrangement in which the foregoing decryption units are included at the same time and combination of encryption methods is performed. The foregoing semiconductor device can be expressed as a semiconductor device having an arrangement in which the foregoing decryption units are included at the same time and combination of encryption methods and order arrangement of the combined encryption methods are performed.

A semiconductor device according to the present invention, in the above arrangement, is preferably such that the decryption section, upon acquisition of the program data, sets the desired order in the switch.

It is possible to enhance encryption by later setting of the order in the switch.

Further, the foregoing semiconductor device can be expressed as a semiconductor device having an arrangement in which the foregoing decryption units are included at the same time and combination of the decryption units and order arrangement of the combined decryption units are performed.

A semiconductor device according to the present invention, in order to solve the problem, preferably includes the foregoing semiconductor device and a storage device storing program data of a programmable circuit, the foregoing semiconductor device and the storage device being integrally packaged.

Integrally packaged semiconductor device realizes a semiconductor device which makes analysis of an internal algorithm difficult.

An electronic apparatus of the present invention, in order to solve the above problem, preferably includes: the foregoing semiconductor device; and a storage device storing program data of the programmable circuit.

The processing to be kept confidential in the electronic apparatus is realized by the foregoing semiconductor device and storage device so that an algorithm thereof can be hidden.

Further, operation of S7 in FIG. 4(b) can be expressed as follows: the OTP area rearranges addresses in accordance with a function for data download to RAM inside the ASIC.

Still further, operation of S10 in FIG. 5(b) can be expressed as follows: the OTP area in the ASIC downloads data to FPGA area only when addresses are those of valid area region.

Yet further, operation of S12 in FIG. 6(b) can be expressed as follows: the OTP area decrypts data in accordance with a function for data download to RAM inside the ASIC.

Specific embodiments or examples implemented in the description of the embodiments only show technical features of the present invention and are not intended to limit the scope of the invention. Variations can be effected within the spirit of the present invention and the scope of the following claims. Also, an embodiment obtained by suitable combinations of technical means disclosed in varied embodiments and different embodiments are also included within the technical scope of the present invention.

1. A semiconductor device including a programmable circuit and a fixed logic circuit,
the semiconductor device comprising:
an input/output section for performing input and output of data to and from the programmable circuit and the fixed logic circuit,
wherein:
the input/output section hides, from an entity outside the semiconductor device, input and output of data to and from the programmable circuit.

2. The semiconductor device according to claim 1, wherein:
the input/output section outputs data to outside of the semiconductor device at a timing shifted from a timing of output from the programmable circuit, so as to hide input and output of data from an entity outside the semiconductor device.

3. The semiconductor device according to claim 2, wherein:
the input/output section performs output at a timing randomly shifted from an output timing of data from the programmable circuit.

4. The semiconductor device according to claim 1, wherein:
the input/output section encrypts an output from the programmable circuit for output from the semiconductor device, so as to hide input and output of data from an entity outside the semiconductor device.

5. The semiconductor device according to claim 1, wherein:
the programmable circuit is a volatile programmable circuit, and
the input/output section acquires program data of the programmable circuit from an entity outside the semiconductor device at a timing except for power-on of an electronic apparatus provided with the semiconductor device, so as to hide input and output of data from an entity outside the semiconductor device.

6. The semiconductor device according to claim 5, wherein:
the input/output section acquires the program data divided into multiple pieces.

7. The semiconductor device according to claim 6, wherein:
the input/output section acquires the program data divided into pieces of random sizes.

8. The semiconductor device according to claim 6, wherein:
the input/output section acquires the program data divided into multiple pieces at random time intervals.

9. The semiconductor device according to claim 5, wherein:
the input/output section has a plurality of interfaces for acquiring the program data.

10. The semiconductor device according to claim 1, further comprising:
a unidirectional hash function section for creating check data from program data of the programmable circuit.

11. The semiconductor device according to claim 1, wherein:
the semiconductor device is an image processing section for performing image processing, and
the programmable circuit performs recognition of a specific document.

12. The semiconductor device according to claim 1, further comprising:
a decryption section for decrypting encrypted program data of the programmable circuit.

13. The semiconductor device according to claim 12, wherein:
at least part of the decryption section is realized by a programmable ROM that is writable and unreadable from an entity outside the semiconductor device.

14. The semiconductor device according to claim 13, wherein:
the programmable ROM is a one time programmable ROM.

15. The semiconductor device according to claim 13, wherein:
the programmable ROM is provided with a key data writing area that, upon writing of key data into the key data wiring area, causes the decryption section to function for decryption of the program data.

16. The semiconductor device according to claim 12, wherein:
the decryption section decrypts program data encrypted by address manipulation.

17. The semiconductor device according to claim 12, wherein:
the decryption section decrypts program data mixed with dummy data.

18. The semiconductor device according to claim 12, wherein:
the decryption section decrypts program data subjected to block encryption.

19. The semiconductor device according to claim 12, wherein:
the decryption section decrypts program data encrypted by rearrangement of data bits.

20. The semiconductor device according to claim 12, wherein:
the decryption section decrypts program data encrypted by compression coding.

21. The semiconductor device according to claim 12, wherein:
the decryption section has: a first decryption unit for decrypting program data encrypted by address manipulation; a second decryption unit for decrypting program data mixed with dummy data; a third decryption unit for decrypting program data subjected to block encryption; a fourth decryption unit for decrypting program data encrypted by rearrangement of data bits; and a fifth decryption unit for decrypting program data encrypted by compression coding,
the input/output section operating as a switch for selecting one for use in a desired order from among the first decryption unit, the second decryption unit, the third decryption unit, the fourth decryption unit, and the fifth decryption unit.

22. The semiconductor device according to claim 21, wherein:
the decryption section, upon acquisition of the program data, sets the desired order in the switch.

23. A semiconductor device including the semiconductor device according to claim 1 and a storage device storing program data of a programmable circuit, the semiconductor device and the storage device being integrally packaged.

24. An electronic apparatus comprising:
a semiconductor device including a programmable circuit and a fixed logic circuit, the semiconductor device comprising: an input/output section for performing input and output of data to and from the programmable circuit and the fixed logic circuit, wherein: the input/output section hides, from an entity outside the semiconductor device, input and output of data to and from the programmable circuit; and
a storage device storing program data of the programmable circuit.
